(19) United States
(12) Patent Application Publication
(10) Pub. No.: US 2005/0261795 A1
(43) Pub. Date: Nov. 24, 2005

(54) Method of making ceramic dental restorations

(75) Inventors: Syamal K. Ghosh, Rochester, NY (US); Donn B. Carlton, Hamlin, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/851,911

(22) Filed: May 21, 2004

(51) Int. Cl. G06F 19/00

(52) U.S. Cl. 700/118; 433/223

(57) ABSTRACT

Dental restorations can be made by acquiring a three-dimensional digitized image of a dental restoration site. A ceramic blank from which volatile organic binders have been removed, is then machined according to the three-dimensional digitized image to form a “brown” ceramic restoration. This material is then sintered using microwave energy to provide a high density ceramic dental restoration corresponding to the dental restoration site. This method can be carried out within a few hours thereby saving the patient several dental visits and enabling the dentist to better serve the patient directly in the office.

### FIELD OF THE INVENTION

This invention relates in general to a method of making ceramic dental restorations. More particularly, this invention relates to a novel method of making three-dimensional ceramic dental restorations using a digitized optical impression of a dental restoration site.

### BACKGROUND OF THE INVENTION

Dental restorations (such as implants, inlays, onlays, and crowns) are generally needed as a preventative measure to treat tooth decay caused by bacteria or normal wear and abrasion that cannot be repaired by fillings. Dental restorations are also used for cosmetic reasons to restore teeth that have suffered physical damage such as a chip, break, or crack. The most important objective in restoration is to reproduce the original physical, functional, and aesthetic characteristics of the tooth as much as possible. The physiological function of the dental restoration is to maintain the health of the periodontium (gums and supporting bones), accommodate the neighboring teeth, and maintain the chewing motions of opposing teeth. Restorations of teeth in these instances usually require the use of an inlay, onlay, or crown.

Teeth themselves are complex and composed of hard tissue structures originally born from specialized cells comprising three distinct tissue structures such as enamel, dentine, and pulp. Enamel is the hard and brittle outer layer generally seen as the clinical crown of the tooth. The elastic modulus (E) of enamel ranges from 65 to 70 GPa. The dentine cells are on the inner side of the tooth bud, between the enamel and the dental pulp. The cells form the dentine as an inward growth. The dentine can be viewed as the main foundation of the tooth, supporting the enamel and providing protection to the pulp, and through its covering below the gums, giving rise to the attachment via a ligament to the surrounding bone. The dentine is much softer (elastic modulus of about 15 to 19 GPa) and more compliant than the enamel. The pulp and the bone are even more compliant than the dentine having an elastic modulus of about 10 GPa.

The evolution and formulation of new materials for dental restoration started in the twentieth century. The development of metal-ceramic restorations and new high-strength ceramics dominated the latter part of that century. Direct bonding of ceramic crowns, veneers, inlays, and onlays to conservative tooth preparations using low-viscosity resin cements is now common practice. Previously, factory-made porcelain facings were used, requiring careful tooth preparation before casting some form of gold backing. The only custom-made crown was the complete porcelain crown baked on a platinum matrix that was very prone to fracture. Thus, the dentist's ability to produce porcelain restorations having aesthetics comparable to natural teeth was severely limited by the necessity of using metal reinforcement and cemented porcelain facings. The introduction of porcelain-fused metals (PFM) in the early 1960s comprising vacuum fired porcelain fused on gold alloys was a pivotal breakthrough in dental restorations. This technology allowed gold frameworks to be masked by fused porcelain that had the appearance and functionality of a natural tooth.

In the late 1960's, a new class of dental restoration material was introduced, commonly known as a glass ceramic. The original glass ceramic material was made from tetrasilicic fluormica crystals (K₂Mg₅SiO₂OF₄), which because of their flexible and plate-like structure, added significant fracture resistance property. However, a significant drawback was that color shade matching could only be achieved with surface colorants that erode relatively faster. More recently, Dentsply International, Inc. (York, Pa.), under the trade name Dicor®, introduced an improved glass ceramic material that is highly translucent and becomes indistinguishable from surrounding teeth. Dicor® ceramic material is used as a cast coping that can be veneered with specially formulated alumna-rich porcelain. However, copings smaller than 1 mm thick tended to crack with use, probably because of a CTE (coefficient of thermal expansion) mismatch or poor resistance to pyroplastic flow during firing of the veneer porcelain. Although Dicor® ceramic material has superior aesthetic attributes, it lacks high fracture toughness and requires direct resin bonding using the acid-etch technique if long-term resistance to cracking is to be achieved.

The advances in dental ceramic materials and restorations continue to be related to improvement in strength, fitting accuracy, durability, aesthetics, and the avoidance of the use of metal substructures both in the posterior and anterior teeth. The primary issues arising from the use of ceramics or glass ceramics as dental restorative materials are biocompatibility, durability, relative ease of manufacturing, and aesthetics. There are several biocompatible ceramics available today that are being used as prosthetics for dental restoration or other implants in human bodies. Compared to other restoration materials such as metals and ceramic-polymer composites, specific ceramics like zirconia and alumina have shown a higher degree of biocompatibility in many clinical studies.

Ceramics have long been accepted for their aesthetic qualities. The use of glass-infiltrated colored dental ceramics can provide replacement structures that can be easily made to imitate tooth structure in color, translucency, radiopacity, and response to different lighting sources. Many clinical studies have demonstrated that today's ceramic restorations are indistinguishable from natural dentition.

Considerable research has been carried out in the industry to find a ceramic system that can provide individually constructed restorations that are small, unique, inexpensive, and will be durable when subjected to cyclic loading in wet and sometimes abrasive conditions. High strength ceramic materials that have properties closer to natural teeth have become available in the market. Advances have been made in improving the flexural strength of dental ceramics by controlling the crystal structure and particle size.

Conventional manual fabrication of ceramic dental restorations is time consuming and labor intensive. The dentist must take an impression of the candidate tooth and the impression mold is used to prepare a die stone or model. The die stone or model is then used by a dental laboratory technician, who typically is located in a remote location from the dentist, to fabricate the final restoration that is then shipped back to the dentist for installation in the patient's mouth. The time to accomplish all of these steps can be few days or even weeks, and the cost, as a result, is relatively high.

All of the drawbacks associated with manual fabrication of dental restoration can be overcome by using computer assisted design/computer assisted machining (CAD/CAM) technology. Equipment has been introduced into the dental industry to automate many aspects of ceramic dental restorations including dental CAD/CAM systems marketed by Siemens, A.G. (Cerec) and Nobel Biocare AD (Procera).

Developed in the early 1980s to deliver ceramic restorations during a single appointment, the Cerec system uses a chair-side serial process for fabrication of dental restorations applying dental CAD/CAM technology. A family of hardware as involved to include the Cerec 2, Cerec 3, Cerec Link, and Cerec InLab. Each system uses software programs with the capability of laboratory or operator use. The current Cerec 3 unit allows for fabrication of a full range of restorations including inlays, onlays, crowns, and veneers.

The Cerec System uses an optical imaging process with the help of an intra-oral camera that digitally records the restoration preparation site to the computer, where it is visualized as an optical impression in the monitor. The computer design software is then used to plot a number of restoration parameters, such as the cavity floor, proximal contact, cavosurface margin, occlusal fissure line, and cusp height and location. Each of the design parameters can be edited with the software to ensure accuracy of fit and reproduction of the desired contour. Once the design is completed, the software program creates a volumetric model of the restoration site from the established parameters. This information is then used by the computer to direct milling of the prefabricated blanks of the selected restorative material into the final three-dimensional restoration. After milling, the “sprue” (detachable piece used to hold the workpiece during milling) is removed. If the fit is satisfactory, the internal surfaces of the restoration are etched, primed with a silane coupling agent, and adhesively cemented to the prepared site with a resin luting agent. Final finishing and polishing are performed as necessary.

The Procera All-Ceram system marketed by Nobel Biocare AD uses a laboratory based serial approach to fabricate all-ceramic restorations comprising high purity alumina coping with a porcelain veneer. The Procera process starts with the dentist preparing the restoration site and taking a conventional impression. The impression is sent to a “spoke” laboratory where a die stone is cast from the impression mold. The surface of the die stone is scanned using a sapphire tipped stylus probe and a turntable that rotates the die as the probe moves up and down. A very accurate digitized surface model is produced, and a CAD software-package is used to design the coping based on this surface. The CAD representation of the coping and die stone surface are sent to the “hub” laboratory electronically, where a duplicate die stone is CNC (computer numerically controlled) ground with a 20% enlargement factor. High purity alumina powder is compacted against the die stone in the form of the desired restoration and some light machining is done to achieve the desired dimensional specifications. The coping is then sintered at high temperature undergoing about 20% shrinkage during densification. The sintered coping is then sent back to the spoke laboratory where a Procera All-Ceram porcelain having the selected color is applied over the coping to build up the occlusal and proximal shape. A lower temperature firing results in good bonding between the porcelain and the coping yielding good tribological and aesthetic properties. The completed restoration is then sent back to the dental office for cementing using standard luting agents. Such a conventional CAD/CAM system cannot produce full crowns, as additional manual labor is required to build up porcelain layers on top of ceramic coping. The Procera method is relatively complex and time consuming involving two different laboratories (spoke and hub) and multiple steps, and like the Cerec system is a serial process.

U.S. Pat. No. 6,495,073 (Bodenmiller et al.) describes a method for the manufacture of ceramic dental restorations wherein a powdery ceramic raw material is compressed to form a “green” (unsintered) ceramic compact that is then machined to form the inner and outer contour. Subsequently, the machined “green” ceramic compact is sintered to form a high-strength shaped ceramic dental restoration. The composition of the “green” ceramic compact is similar to that of chalk, allowing ease of machining.

Another method of manufacturing ceramic dental restorations is disclosed in U.S. Pat. No. 6,354,836 (Panzera et al.) wherein a ceramic block is formed first by compressing ceramic powder that is combined with an organic binder. This “green” ceramic block is then partially sintered to a bisque density of less than about 85% of the final fully-sintered density. The partially sintered ceramic block is then milled to a desired restoration shape and sintered again to a final density.

Increasingly, there is a desire in the art to find improved methods to fabricate dental restorations requiring fewer process steps. It would be particularly desirable to provide a means for dental restorations in a dentist's office while the patient waits. However, using the methods of U.S. Pat. No. 6,495,073, it is not always possible to machine intricate features in the chalk-like “green” ceramic blocks without causing damage to the blocks. To reduce the possibility of damage, green ceramic block can be embedded in wax before machining and subsequently removing the wax from the machined ceramic part. This is a very time consuming and tedious process and may not be suitable for rapid manufacture in a dentist's office. Similarly, machining a partially sintered ceramic block as described in U.S. Pat. No. 6,354,836 is not desirable because it requires diamond tooling and a slower machining process in order to obtain a defect-free ceramic restoration. Moreover, the process of this patent requires two sintering steps.

Thus, it would be very desirable to fabricate dental restorations in a timely and cost-effective manner so that the physical, aesthetic, and functional attributes of the restorations are comparable to those of natural dentition.

### SUMMARY OF THE INVENTION

This invention provides a method for making a dental restoration comprising:
A) acquiring a three-dimensional digitized image of a dental restoration site,
B) providing a “green” ceramic blank containing an organic binder and volatizing the organic binder to provide a “brown” ceramic blank,
C) machining the “brown” ceramic blank according to the three-dimensional digitized image to form a corresponding “brown” ceramic restoration, and
D) sintering the “brown” ceramic restoration using microwave energy to provide a full-density ceramic dental restoration.

In preferred embodiments, the method of this invention for making one or more dental restorations comprises:
A′) acquiring three-dimensional digitized images of one or more dental restoration sites,
B′) creating a data file for each of the three-dimensional digitized images and adding a predetermined enlargement factor to the linear dimension of each of the three-dimensional digitized images,
C′) transferring the one or more data files to a multi-axis CNC milling machine,
D′) providing one or more “brown” ceramic blanks from which organic binders have been volatized from one or more “green” ceramic blanks,
E′) machining the one or more brown ceramic blanks to form one or more brown ceramic restorations, and
F′) sintering the one or more brown ceramic restorations using microwave energy to provide one or more full-density ceramic dental restorations.

The method of the present invention has a number of advantages. For example, machining of a “brown” ceramic blank reduces the machining time significantly compared to machining a sintered full-density ceramic blank. In addition, machining of a “brown” ceramic blank can be performed using less expensive carbide or high-speed steel tool bits, whereas diamond tool bits must be used for machining full-density sintered ceramic blanks.

Another advantage of the present invention is removing organic binders from green ceramic blank makes it stronger without diminishing the ease of machining. Thus, the “brown” ceramic blanks can be machined at a faster speed using conventional tooling. Removing the organic binder(s) essentially simplifies the microwave sintering process.

Roughness of the resulting dental restorations is lessened by the method of this invention because sintering causes 20-22% shrinkage in a linear direction and the density is almost doubled. Roughness that is caused by cutting tools during milling is, in effect, healed by the sintering process. Moreover, only one sintering step is required in the method of the present invention.

In addition, the present invention requires no “post-sintering” polishing, that is, buffing the dental restoration to make it smooth so that the patient does not feel rough areas.

The turnaround time for a patient to be fitted with a ceramic dental restoration can be as long as 4 to 8 weeks involving more than a single trip to the dentist's office. The present invention reduces the time considerably. Because of all of these advantages, it is more likely that a dental restoration can be prepared in a dentist's office, as well as a conventional dental laboratory, using more conventional tools and a relatively inexpensive system comprising digital imaging, machining, and sintering equipment. Multiple appointments for the patient are less likely and the patient can be served more quickly.

### BRIEF DESCRIPTION OF THE DRAWINGS

FIG. 1 is a process flow chart for fabrication of ceramic dental restorations according to the present invention.

FIG. 2 is a graphical representation of a stylus surface profile of a “brown” ceramic restoration that was machined prior to sintering according to prior art methods.

FIG. 3 is a graphical representation of a stylus surface profile of a sintered ceramic full density restoration wherein sintering was performed after machining according to the method of the present invention.

### DETAILED DESCRIPTION OF THE INVENTION

Definitions

By “green” ceramic blank, we mean a ceramic material that has been compacted from agglomerates of powder containing one or more organic binders.

By “brown” ceramic blank, we mean a compacted ceramic article that has been “debinded” by removing all of the organic binder(s) by heating (see conditions described below).

By “brown” ceramic restoration, we mean a machined “brown” ceramic blank prior to sintering in the form of an implant, inlay, onlay, or crown used as a dental restoration.

By “step-over”, we mean the cutting depth of the ball end mill at the beginning of each translational motion of the tool (ball end mill) or the work piece (“brown” ceramic restoration) during machining.

By “full density” ceramic, we mean the density of the ceramic composition is at least 95% of the theoretical density of that particular ceramic as calculated from a unit cell of the crystal structure.

Details of the Invention

Dental restorations are prepared according to the present invention in any suitable location having the appropriate equipment, much of which is conventional and relatively easy to use. The dentist would obtain a three-dimensional digitized image of a dental restoration site in the patient using a suitable imaging apparatus and software, such as the Cerec System described above. The three-dimensional digitized image can be stored as a data file and used immediately or at a later time. It may also be desirable to add a predetermined enlargement factor to the linear dimension of each digitized image in order to accommodate the shrinkage that takes place during sintering.

The following description refers predominantly to the preparation of a single dental restoration but it would be apparent to one skilled in the art that multiple dental restorations can be prepared simultaneously by obtaining the requisite three-dimensional digitized images and following the noted method steps simultaneously or sequentially for the respective digital images.

The necessary “green” ceramic blanks are made from ceramic powders. Such powders and “green” ceramic blanks can be obtained from several commercial sources. These ceramic blanks can be composed of a variety of useful ceramic compositions including, but not limited to, zirconia, alumina, mullite, zirconia-alumina composites, other oxides, glass-ceramic materials and mixtures thereof. Tetragonal zirconia polycrystals (TZP), alumina-toughened zirconia (ATZ), and zirconia-toughened alumina (ZTA) composites are preferred. Zirconia and ATZ composites are most preferred. The selected ceramic powders have particle size ranging from about 0.3 to about 3.0 μm (preferably from about 0.3 to about 1.0 μm) and a normal particle size distribution. The median particle size is typically 0.6 μm. Particular useful ceramic compositions are described in U.S. Pat. No. 5,411,690 (Ghosh et al.) and U.S. Pat. No. 5,733,588 (Chatterjee et al.), both incorporated herein by reference. Zirconia and zirconia-alumina composites (such as ZTA and ATZ) can be purchased from Zirconia Sales of America (Marietta, Ga.).

The “green” ceramic blanks typically include one or more organic binders to hold the compacted ceramic particles together. The blanks are typically prepared by uniaxial dry pressing, cold isostatic pressing, slip casting, or injection molding a ceramic powder in the presence of one or more of these organic binders such as poly(vinyl alcohol), waxes, and thermoplastic resins and acrylics. The preferred method of molding is either cold isostatic pressing or uniaxial dry pressing. The amount of binder(s) is generally up to 8% (based on the total blank volume) and generally from about 3 to about 5% (by volume). These binders must be removed from the “green” ceramic blank usually by heating the blanks to a very high predetermined temperature for a suitable period of time. For example, the “green” ceramic blanks can be heated to a temperature within the range of from about 400 to about 1000° C. (preferably from about 600 to about 1000° C.) for from about 60 to about 300 minutes (preferably about 120 minutes). Heating and cooling during this process may be carried out in steps of different temperatures for different times, or the heating and cooling may be changed gradually over time such as at a rate of from about 0.1 to about 1° C./min. This process essentially volatilizes the organic binder(s) and provides the “brown” ceramic blank.

Once the organic binders have been removed, the “brown” ceramic blank is machined using suitable equipment such as multi-axis CNC milling machine. Other conventional milling machines can be used for this purpose. The three-dimensional digitized images are transferred in electronic form to the milling machine and used to direct the machining process to give the blank the desired shape and size.

The machined “brown” ceramic restoration is then sintered using microwave energy to provide a full density ceramic dental restoration. Ideally, the density would be as close to 100% as possible, and the crystal structure would be as close to 100% tetragonal as possible.

Sintering can be carried out using any suitable source of microwave energy such as conventional microwave oven equipped with a silicon carbide enclosure as a susceptor. Typically, sintering includes a gradual heating period, a period at the “peak” sintering temperature (also known as the “soak” time), and a cooling period. The total time for these three periods can be from about 20 to about 60 minutes (preferably from about 20 to about 40 minutes). The “soak” time is generally from about 2 to about 10 minutes (preferably from about 2 to about 5 minutes) and is carried out at a “peak” temperature of from about 1400 to about 1600° C. (preferably from about 1450 to about 1550° C.). The rate of heating and cooling can be adjusted by one skilled in the art to provide optimum results without ceramic cracking. The rate would depend, for example, upon the desired sintering temperature, ceramic being evaluated, and microwave energy frequency. The microwave energy frequency is generally from about 2 to about 20 GHz and preferably from about 2.4 to about 2.6 GHz.

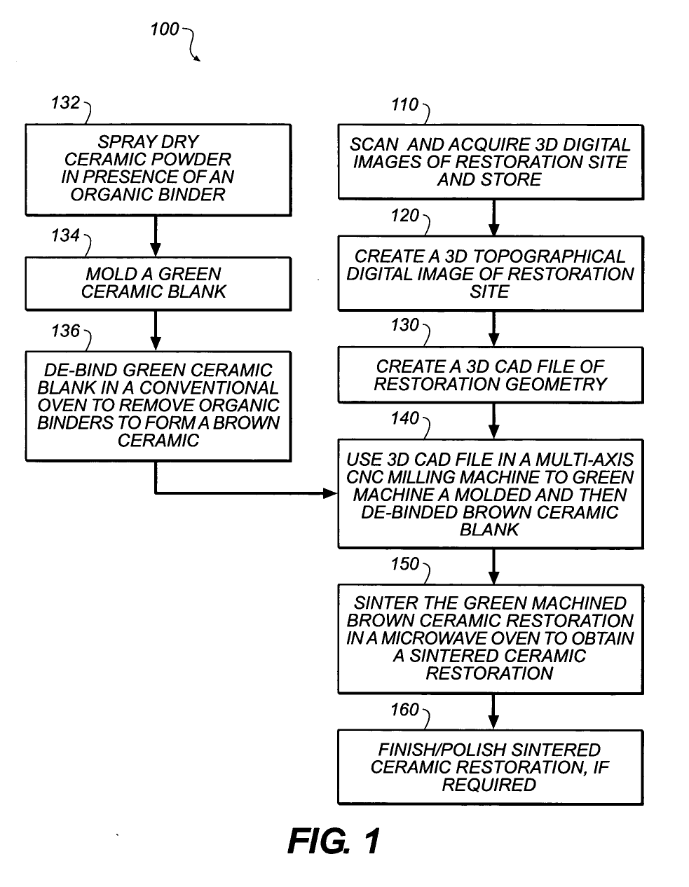

FIG. 1 shows a highly schematic process flow chart 100 with further details for making one or more ceramic dental restorations. Referring to FIG. 1, the process step 110 involves preparing a restoration site in the patient's mouth for inserting the ceramic dental restoration and acquiring a succession of digital images of the prepared restoration site, for example, using an intra-oral digital camera. The preferred digital images are converted into a three-dimensional topographical representation (step 120), corresponding to preferably an enlarged scale of the preparation site. The enlargement is used to accommodate the shrinkage incurred during subsequent sintering step. The linear dimension is enlarged by a factor of from 15 to 25% depending on the chemical composition of ceramic materials to be used. In an alternative embodiment, an impression of the restoration site can be taken that can be scanned to produce a three-dimensional digital image data file.

In process step 130, the three-dimensional digital images are then manipulated to generate a computer-assisted design (CAD) file or a similar data file that is capable of being used in subsequent steps in fabrication of a three-dimensional dental restoration corresponding to the preparation site. The resulting three-dimensional (“3D”) CAD file is used in process step 140 in milling a “brown” ceramic blank that is formed by a process described as follows.

Referring to FIG. 1 once again, process steps 132, 134 and 136 describe a preferred method of forming the “brown” ceramic blank. Process step 132 comprises spray drying the selected ceramic powders in the presence of one or more organic binders such as poly(vinyl alcohol) (PVA). A predetermined amount of spray dried ceramic powder is then transferred to a mold to form a “green” ceramic blank in accordance with process step 134. The molded “green” ceramic blank is next “debinded” as shown in process step 136 in an air-furnace so that organic binders are burned off cleanly (volatilized) from the molded “green” ceramic blank yielding a “brown” ceramic blank with excellent physical properties for ease of handling and machining.

This “brown” ceramic blank is then milled in process step 140 using a multi-axis milling machine equipped with conventional carbide or high speed tools to form a “brown” ceramic restoration under the direction of the 3D CAD generated file as described hereinbefore. The machining process is carried out using a selected tool geometry, tool speed and feed rate, the details of which will be discussed later as a part of working examples.

Referring to FIG. 1 again, the machined “brown” ceramic restoration is nested inside a SiC housing and can then be placed in a 1 kW power microwave oven driven by 500 Watt to 3.0 kW power in accordance with process step 150 and heated at a frequency of 2.45 GHz for a period of 20 to 60 minutes, including heating and cooling time (preferably 30 minutes) so that a full-density sintered ceramic restoration of desired shape is obtained. This is the sole sintering step used in the method of this invention. The actual heating time during sintering is generally from about 2 to about 10 minutes. Machining step 140 is carried out such a manner that the sintered ceramic restoration satisfies all of the requirements for surface finish and restoration dimensions for accurate fitting into the restoration site without further machining.

A final finishing step 160 may be carried out to include a cosmetic polishing.

The invention is further illustrated by the following examples of its practice.

### EXAMPLES 1-3

A zirconia alloy having 3 mole % Y₂O₃ was obtained from Zirconia Sales of America (Marietta, Ga.). The alloy powder had an agglomerate size range of from 30 to 60 μm, a grain size range of from 0.1 to 0.6 μm, and an average grain size of 0.3 μm. Polyvinyl alcohol (4% by volume) was added to the zirconia ceramic powder as a binder by spray drying. The powder was compacted by dry pressing in a mold at a compacting pressure ranging from 10,000 to 30,000 psi (about 70-210 MPa), and an average compacting pressure of 15,000 psi (about 105 MPa) for at least 10 seconds and with a fill ratio of about 3:1, to compact the powder into “green” ceramic blanks. The PVA organic binder was burned off (volatilized) in an air furnace by sequentially heating from room temperature to 300° C. at a rate of 0.3° C./min., from 300° C. to 400° C. at a rate of 0.1° C./min and maintaining the temperature at 600° C. for at least 120 minutes, and then cooled to room temperature at a rate of 1.6° C./min. Infrared analysis was performed to make sure that the PVA was removed so that useful “brown” ceramic blanks were formed.

These “brown” ceramic blanks were then milled in a 3-axis milling machine to form “brown” ceramic restorations as described above using the step-overs of 12.5, 25 and 125 μm (Examples 1, 2, and 3 respectively). The “brown” ceramic restorations were then sintered at about 1500° C. using microwave energy of 2.4 GHz for a period of 30 minutes. The density of each sintered ceramic restoration was measured using a Mettler AT261 DeltaRange balance. The theoretical density of tetragonal zirconia polycrystal (TZP) is about 6.08 g/cm³ as calculated from the unit cell dimensions measured by X-ray diffraction. The sintered ceramic restorations of Examples 1-3 had a density greater than 95% of the theoretical density of 6.08 g/cm³.

X-ray diffraction analysis for each ceramic restoration was performed using a Model RU300 X-ray diffractometer (Rigaku Corporation, Japan). The properties of the restorations are presented below in TABLE I. Ceramic restorations are predominantly tetragonal zirconia polycrystals.

The average surface roughness, Ra, of the ceramic restorations for Examples 1, 2 and 3 were 0.604, 0.772 and 0.736 μm, respectively, suggesting that surface roughness of the ceramic restorations made according to the present invention were as good as or better than those prepared using the methods of the prior art.

The mean roughness depth (Rz) varied between 2.733 and 4.257 μm, the lowest value for the ceramic restorations milled at 12.5 μm step-over. A single roughness depth may be defined as the vertical distance between the highest peak and the deepest valley within a sampling length. Maximum roughness depth (Rₘₐₓ), the largest single roughness depth within the sampling length, was the lowest for the ceramic restoration milled at 12.5 μm step-over as in Example 1.

### COMPARATIVE EXAMPLE 1

A dental restoration was fabricated using the method described in U.S. Pat. No. 6,454,629 (Basler et al.). This ceramic restoration was procured from a local dentist wherein the dental restoration was milled from a full density ceramic block using a Cerec 3 CAD/CAM milling machine. The average surface roughness (Ra) was 1.069 μm that is significantly higher than the restorations prepared according to the present invention.

### COMPARATIVE EXAMPLE 2

A ceramic restoration was fabricated in a similar fashion as described in Comparative Example 1 but an additional polishing step was used to improve the surface roughness. The average surface roughness (Ra) was improved significantly to 0.477 μm.

### COMPARATIVE EXAMPLE 3

A typical ceramic dental restoration that is generally used for a patient was procured from a dental laboratory. The fabrication history of the ceramic restoration is not known but its surface measurements indicate that the present invention can be used to produce a ceramic restoration having surface characteristics as good as or better than those made using known technology.

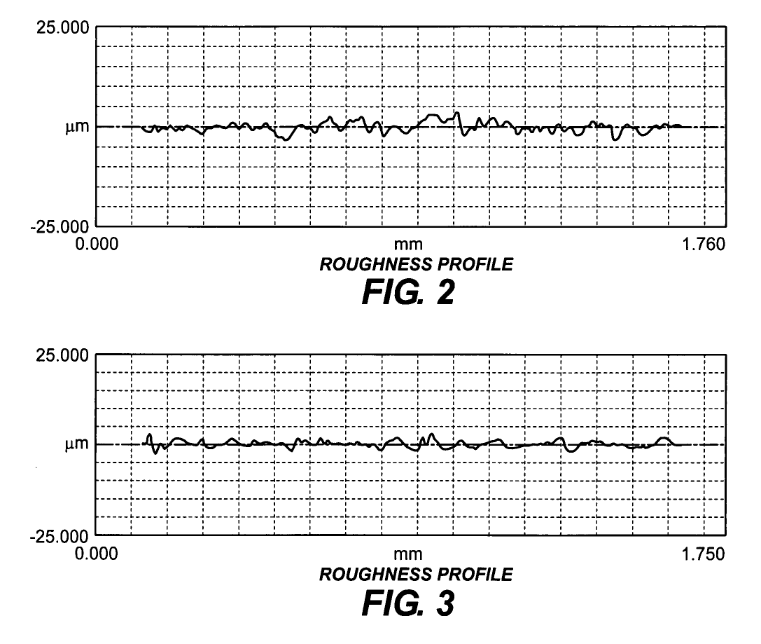

Referring to FIG. 2, a surface profile of a machined “brown” ceramic restoration is shown. It had been machined using a Herco 3-axis milling machine with a standard 3 mm diameter tungsten carbide ball end mill. The surface feed speed of the “brown” ceramic blank (workpiece) was maintained at 64 cm/min., the cutting speed of the ball end mill was 3000 rpm, and the cutting tool step-over was kept at 12.5 μm. Alternatively, the ball end mill can have a translational motion (surface speed) of 64 cm/min while the “brown” ceramic blank is kept stationary. The average surface roughness (Ra) of the milled “brown” ceramic restoration using the above mentioned milling parameters was 1.2 μm. A series of “brown” ceramic blanks were milled at different machining parameters wherein the following ranges seem to produce the most optimum results with respect to surface finish after sintering: surface speed of from about 20 to about 150 cm/min (preferably from about 50 to about 80 cm/min), cutting speeds of from about 1000 to about 10,000 rpm (preferably from about 2000 to about 4000 rpm), and cutting tool step-overs of from about 5 to about 200 μm (preferably from about 10 to about 20 μm). The average surface roughness (Ra) of the “brown” ceramic restoration (immediately after milling and prior to sintering) varied between 1.0 and 2.0 μm depending upon the machining parameters such as surface feed speed, cutting speed, and more importantly, the step-over of the cutting tool.

Referring to FIG. 3, a surface profile of a sintered full density ceramic restoration is shown wherein the sintering process was done using a brown ceramic restoration milled at 2.5 μm step-over, cutting speed of 3000 rpm, and the surface speed of the cutting tool ball end mill was 64 cm/min. Sintering was undertaken using either a conventional heating oven or a microwave oven that was operated at 2.45 GHz and 1 kW of power. The sintering temperature was 1500° C. and the soak time for sintering was 120 minutes and 5 minutes for the conventional oven and microwave, respectively. The average surface roughness (Ra) of the sintered ceramic restorations prepared according to the present invention was 0.4-0.8 μm. The surface characteristics were smooth enough that they did not require any post-sintering finishing. The experimental results of some ceramic restorations prepared according to the present invention as well as those prepared using known methods are shown in TABLE I below.

TABLE I

| | Fabrication | Density | Crystal | Ra | Rz | Rₘₐₓ |
|---|---|---|---|---|---|---|
| Example | Process | g/cm³ | Structure | (μm) | (μm) | (μm) |
| Example 1 | 12.5 μm tool | 6.02 | Tetragonal | 0.604 | 2.733 | 3.808 |
| | step-over | | | | | |
| Example 2 | 25 μm tool | 6.01 | Tetragonal | 0.772 | 4.257 | 7.729 |
| | step-over | | | | | |
| Example 3 | 125 μm tool | 6.02 | Tetragonal | 0.736 | 4.066 | 5.967 |
| | step-over | | | | | |
| Comparative | Milled Cerec | | | 1.069 | 5.306 | 6.873 |
| Example 1 | | | | | | |
| Comparative | Polished | | | 0.477 | 2.435 | 4.580 |
| Example 2 | Cerec | | | | | |
| Comparative | Dental Lab | | | 0.849 | 3.365 | 10.023 |
| Example 3 | | | | | | |

The invention has been described in detail with particular reference to certain preferred embodiments thereof, but it will be understood that variations and modifications can be effected within the spirit and scope of the invention.

1. A method for making a dental restoration comprising:
A) acquiring a three-dimensional digitized image of a dental restoration site,
B) providing a “green” ceramic blank comprising zirconia and an organic binder and volatizing said organic binder to provide a “brown” ceramic blank comprising zirconia,
C) machining said “brown” ceramic blank according to said three-dimensional digitized image to form a corresponding “brown” ceramic restoration comprising zirconia, and
D) sintering said “brown” ceramic restoration using microwave energy to provide a ceramic dental restoration comprising zirconia,
wherein said organic binder is volatized from said “green” ceramic blank by heating in the range of from 400 to about 1000° C. for from about 60 to about 300 minutes.

2. The method of claim 1 wherein a data file of said three-dimensional digitized image is created.

3. The method of claim 2 wherein a predetermined enlargement factor is added to the linear dimension of said three-dimensional digitized image.

4. The method of claim 2 wherein said machining is carried out using a multi-axis CNC milling machine.

5. The method of claim 1 wherein a plurality of dental restorations are prepared simultaneously by carrying out steps A through D simultaneously using multiple three-dimensional digitized images and “green” dental blanks.

6. (canceled)

7. The method of claim 1 wherein said “green” ceramic blank is a molded green ceramic blank that has been prepared by uniaxial dry pressing, cold isostatic pressing, slip casting, or injection molding a ceramic powder in the presence of one or more organic binders.

8. The method of claim 7 wherein said “green” ceramic blank comprises polyvinyl alcohol.

9. The method of claim 1 wherein said “brown” ceramic restoration is sintered using microwave energy at a frequency of from about 2 to about 20 GHz for from about 2 to about 10 minutes at peak temperature of from about 1400 to about 1600° C.

10. The method of claim 9 wherein the total sintering time including heating and cooling is from about 20 to about 60 minutes.

11. The method of claim 9 wherein the frequency of said microwave energy is from about 2.4 to about 2.6 GHz.

12. (canceled)

13. The method of claim 1 wherein said “brown” ceramic restoration is sintered to provide a fully density ceramic dental restoration.

14. A method for making one or more dental restorations comprising:
A′) acquiring three-dimensional digitized images of one or more dental restoration sites,
B′) creating a data file for each of said three-dimensional digitized images and adding a predetermined enlargement factor to the linear dimension of each of said three-dimensional digitized images,
C′) transferring said one or more data files to a multi-axis CNC milling machine,
D′) providing one or more “brown” ceramic blanks comprising zirconia from which organic binders have been volatized from one or more “green” ceramic blanks comprising zirconia, by heating in the range of from 400 to about 1000° C. for from about 60 to about 300 minutes,
E′) machining said one or more brown ceramic blanks to form one or more brown ceramic restorations comprising zirconia, and
F′) sintering said one or more brown ceramic restorations using microwave energy to provide one or more full-density ceramic dental restorations comprising zirconia.

15. The method of claim 14 wherein said one or more “green” ceramic blanks comprise zirconia and polyvinyl alcohol, and
said one or more “brown” ceramic restorations are sintered using microwave energy at a frequency of from about 2.4 to about 2.6 GHz for from about 2 to about 5 minutes at peak temperature of from about 1450 to about 1550° C.
